(19) United States
(12) Patent Application Publication
(10) Pub. No.: US 2015/0016708 A1
(43) Pub. Date: Jan. 15, 2015

(54) PATTERN CHARACTERISATION METHOD

(71) Applicant: COMMISSARIAT A L'ENERGIE ATOMIQUE ET AUX ENERGIES ALTERNATIVES, Paris (FR)

(72) Inventors: Johann Foucher, Meylan (FR); Romain Feilleux, Gif sur Yvette (FR)

(21) Appl. No.: 14/367,644

(22) PCT Filed: Dec. 20, 2012
(86) PCT No.: PCT/EP2012/076263

§ 371 Date: Jun. 20, 2014

(30) Foreign Application Priority Data
Dec. 22, 2011 (FR) 1162324

(51) Int. Cl. G06T 7/00

(52) U.S. Cl. CPC G06T 7/001; G06T 2207/30148
USPC 382/149

(57) ABSTRACT

A method of characterizing a pattern includes determining an image of the contour of the pattern to be characterized with an imagining instrumentation; processing the image, the processing including determining a plurality of points located along the contour and sampled according to a given sampling interval; for each point, identifying a point located on a reference contour and corresponding to the same sampling interval number and determining a dimensionless intermediate coefficient representative of the deviation between the point and the corresponding point on the reference contour; determining a final dimensionless coefficient on the basis of the set of intermediate coefficients corresponding to the plurality of points, the final coefficient being representative of the deviation between the contour of the pattern to be characterized and the reference contour.

This invention relates to the field of metrology and its purpose is a pattern characterisation method. The method according to the invention is particularly adapted to characterisation of patterns used in microelectronic integrated circuits obtained in the microelectronics industry.

In microelectronics, technological progress is accompanied by needs for characterisation instruments. For each technological node, metrology tools have to be increasingly efficient and be capable of making dimensional checks of fabricated devices.

To achieve this, the semiconductor industry defines and monitors dimensions of fabricated products using the CD (Critical Dimension). The continuing reduction in the critical dimension of circuits involves a corresponding adaptation of measurement methods. Simultaneously, the increase in the size of wafers and costs per wafer make it necessary to test and detect defects as soon as possible and in fact, at every step of the fabrication process, both during research and development processes and production.

One of the problems with this concept of the Critical Dimension CD lies in its definition that can vary depending on the type of patterns being studied; thus, the CD for holes or pads will be the diameter; the CD for a line or a trench will be the width of the line or the trench.

Apart from the very definition of the CD, the vertical position at which it is measured varies depending on the patterns to be characterised. Thus, the CD of a transistor gate will be measured as low as possible while CDs of a gate contact or an interconnection line will be measured as high as possible.

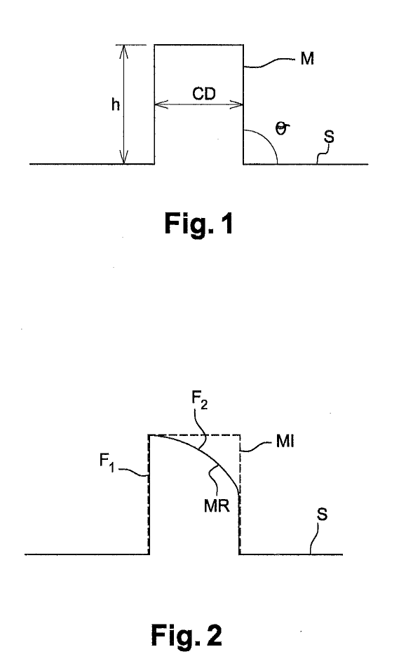

Furthermore, the precision requirement for pattern characterisation obliges manufacturers to use dimensional parameters other than the CD. Thus as shown in FIG. 1, it may be useful to access not only the CD of the pattern M but also the angle θ formed between the flanks of the pattern M and the substrate S or the height h of the pattern M. Thus, there is a general progressive movement towards the most global possible dimensional control of the pattern.

Furthermore, the measurement of the CD remains very local; but positioning, particularly vertical, is not very well controlled with techniques used in production, for example scanning atomic force electron microscopy (CD-SEM—Critical Dimension-Scanning Electron Microscope), scatterometry or three-dimensional Atomic Force Microscopy (CD-AFM—Critical Dimension-Atomic Force Microscopy). Each technique (Scatterometry, CD-SEM, CD-AFM) independently measures the critical dimensions and/or the angles of patterns and/or the height. Thus as technological steps progress, there is no relation between the different measurements made at each fabrication level of an integrated circuit. It will also be understood that the value of the CD depends on the calibration of the machine used and therefore varies not only from one measurement technology to another but also even within a single technology.

Finally there is a continuing reduction in technological nodes such that etching defects are increasingly critical. Thus, in processes with multiple exposure, for example for manufacturing nitride spacers according to the “double patterning” technique, isotropic plasma etching steps are used on conforming deposits of nitride leading to the presence of patterns that are not perfectly rectangular like patterns obtained by optical lithography might be. FIG. 2 shows this phenomenon and shows a real MR pattern shown in solid lines (for example a nitride spacer obtained by multiple exposure techniques) superposed on an ideal MI pattern shown by dashed lines in the form of a perfectly expected pattern. In the ideal case, the shape of the expected pattern MI is the shape of a line made using optical lithography, close to a perfect rectangle. But problems inherent to the conforming deposit of nitride lead to the formation of a significantly different geometry. In this precise case, it can be clearly seen that there is a non-negligible difference between the result and the ideal situation defined by a perfect rectangle; thus the real pattern MR has a flank F1 close to the flank of the ideal pattern MI and a very rounded second flank F2 at a distance from the corresponding flank of the pattern MI. It will easily be understood that an approach based only on the CD at mid-height will be insufficient to identify the difference from reality (it will be even worse at the bottom of the pattern). However, knowledge of this difference is important in that it may have an influence on the results obtained in conventional CD metrology. It should also be noted that the differences between the real pattern and the ideal pattern are not necessarily symmetric about each side of the XX′ axis of symmetry of the ideal pattern; thus, only the flank F2 is affected in the case shown in FIG. 2, while the flank F1 is almost identical to the flank of the ideal pattern.

In this context, the purpose of this invention is to provide a characterisation method that can be used in production (to identify fabrication problems) or in research and development (for development or optimisation of technological methods), in order to give a precise image of the pattern independent of the calibration of the metrology machines used and relevant at all fabrication levels to be characterised (for example at lithography level or etching level).

To achieve this, the invention discloses a method of characterising a pattern comprising steps to:
determine an image of the contour of the pattern to be characterised using imagery instrumentation;
process said image including determination of a plurality of points located along said contour and sampled at a given sampling rate;
for each point, identify a point located on a reference contour and corresponding to the same sampling step number and determine an intermediate dimensionless coefficient representing the difference between said point and the corresponding point on said reference contour;
determine a final dimensionless coefficient using all intermediate coefficients corresponding to said plurality of points, said final coefficient being representative of the difference between the contour of the pattern to be characterised and the reference contour.

With the invention, a unitless measurement parameter is advantageously used starting from an image of the pattern, in order to give a precise image of said pattern. Since this parameter is unitless, it is decorrelated from the calibration of measurement instruments.

The method according to the invention discloses how to determine a parameter that is a difference estimator from an ideal contour; unlike existing CD metrology (possibly together with obtaining other angular measurements or heights), this estimator gives a global image of the contour and can therefore overcome problems related to the presence of defects not detected by measurement of the CD alone and/or the complex geometry of patterns. It should be noted that the method according to the invention will be more precise when the sampling step is small, it being understood that the sampling step will be dependent on the technological node corresponding to the pattern.

Depending on whether the dimensionless estimator is more or less different from a threshold value, the method according to the invention can be used to determine whether or not the pattern is conforming with the reference pattern.

The method according to the invention may have one or several of the following characteristics taken individually or in any technically possible combination:
the number of points determined along the contour is more than or equal to the ratio between the length of the contour and a predetermined resolution value;
each sampled point is identified by a pair of coordinates in a two-dimensional coordinate system, Xi representing the abscissa of the point and Yi representing the ordinate of the point, where i varies from 1 to N where N is the number of sampling points, said determination of the intermediate coefficient of the abscissa point Xi being made by comparing its ordinate Yi with the ordinate Ymi of the reference contour with the same abscissa Xi;
said intermediate coefficient Ci of the abscissa point Xi is given by one of the following two formulas:

$$Ci ( \% ) = \frac{( Ymi - Yi ) * 100}{Ymi}$$

$$or$$

$$Ci ( \% ) = \frac{Yi * 100}{Ymi} ;$$

said final dimensionless coefficient C_{final} is given by the following formula:

$$Cfinal ( \% ) = \frac{{\sum }_{i = 1}^{i = N} Ci}{N} ;$$

said step to determine an image of the contour of the pattern to be characterised is made by imagery instrumentation making use of one of the following techniques:
   three-dimensional atomic force microscopy;
   scanning atomic force microscopy;
   transmission electron microscopy;
the method according to the invention includes a step to determine the part of the contour on which sampling is made;
only half of said contour is sampled when said contour has an axis of symmetry.

Other characteristics and advantages of the invention will become clear after reading the following description given for guidance and in no way limitative, with reference to the appended figures in which:

FIG. 1 shows the different dimensional parameters known in the state of the art;

FIG. 2 diagrammatically shows the differences between a real pattern and an ideal pattern;

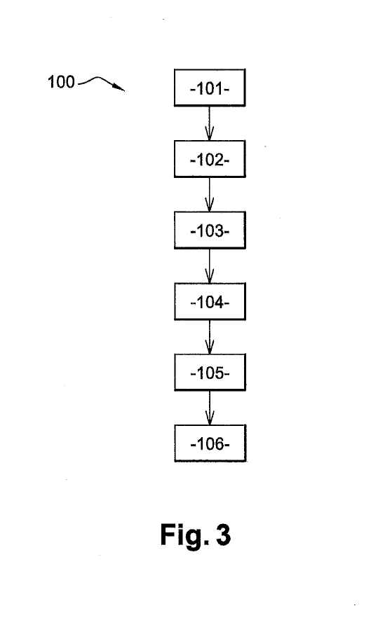

FIG. 3 shows the different steps in the method according to the invention;

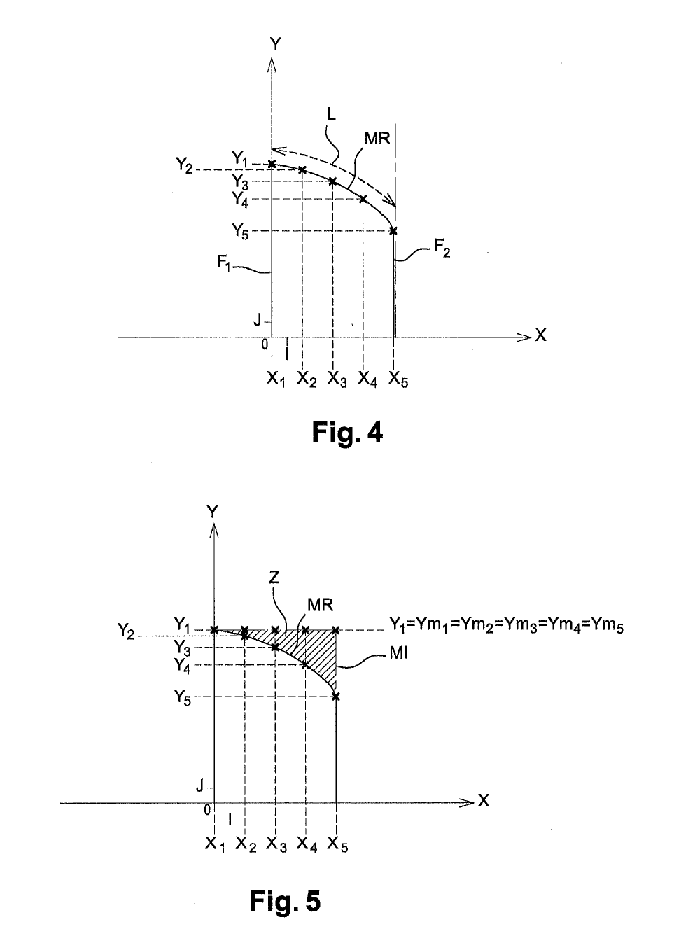

FIG. 4 shows the principle of the step to determine points on the contour using the method in FIG. 3;

FIG. 5 shows the principle of the step to determine the intermediate coefficients using the method in FIG. 3;

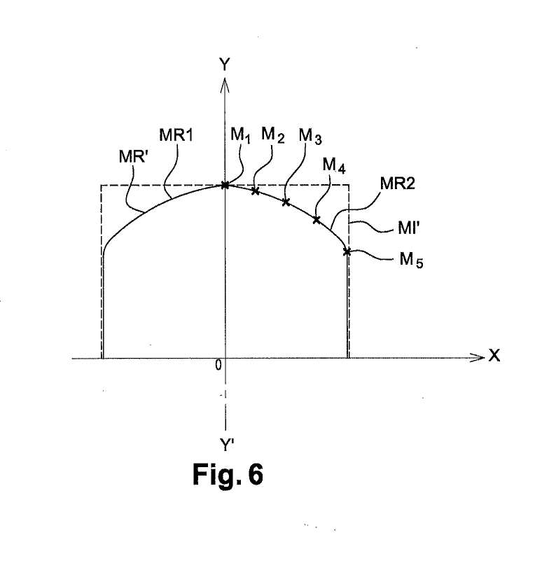

FIG. 6 shows the principle of the step to determine a reference point using the method in FIG. 3;

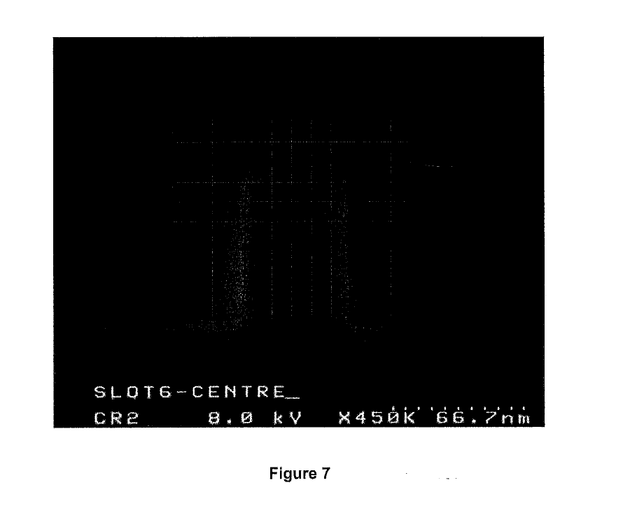

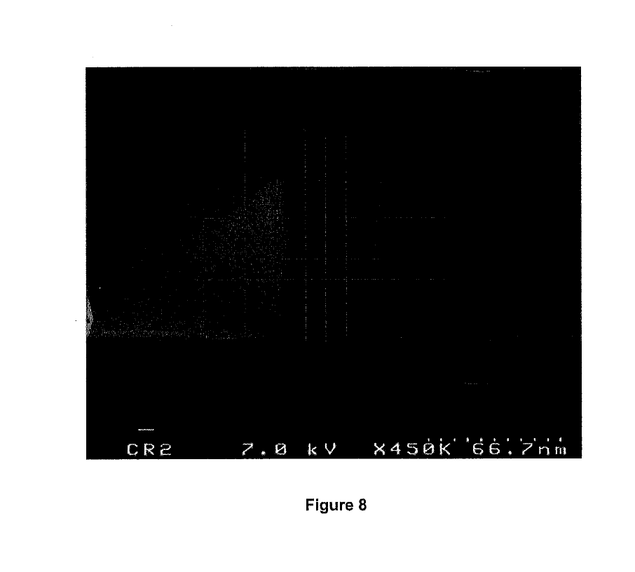

FIGS. 7 and 8 each represent an image of a pattern obtained by scanning electron microscopy.

FIG. 3 diagrammatically shows the different steps in the method 100 according to the invention.

The characterisation method 100 according to the invention is aimed at characterising any pattern (holes, pads, line, trench, etc.) forming part of a microelectronic circuit. The material used for the pattern may also be arbitrary. This pattern may for example be an isolated pattern or it may belong to a network of periodically repeated patterns. It may be a pattern obtained after any step (lithography, etching, etc.) in a fabrication process.

We will illustrate use of the method 100 in the case of a pattern like the pattern MR shown in FIG. 1.

This method 100 comprises:
a step 101 to make a contour image of the pattern MR to be characterised;
a step 102 to determine a plurality of points located along the imaged contour in step 101;
a step 103 to determine a reference point depending on whether or not the pattern has an axis of symmetry; it will be noted that this step is optional;
a step 104 to determine a plurality of coefficients called intermediate coefficients Ci where i varies from 1 to N where N is the number of points determined in step 102; each intermediate coefficient is a dimensionless coefficient corresponding to a point determined in step 102 and represents the difference between this point and the corresponding point on an ideal contour called the reference contour, such as the contour MI in FIG. 2;
a step 105 to determine a final dimensionless coefficient C_{final} starting from a set of intermediate coefficients Ci determined in step 104;
a step 106 to compare the final coefficient C_{final} with a threshold value so as to determine if the pattern MR to be characterised is sufficiently close to the reference pattern MI.

Step 101 consists of making a contour image of the pattern MR. This image may be obtained by any type of imagery technique, for example three-dimensional Atomic Force Microscopy (CD-AFM—Critical Dimension-Atomic Force Microscopy), scanning electron microscopy (CD-SEM—Critical Dimension-Scanning Electron Microscope), or TEM (Transmission Electron Microscopy). This step 101 can provide a sectional image of the pattern to be characterised.

Step 102 is an image processing step as done in step 101 and consists of sampling N points belonging to the contour of the pattern to be characterised. FIG. 4 shows the principle of this step 102 during processing of the pattern MR as shown in FIG. 2. Firstly, the number of points N necessary for processing has to be determined. This number N of points depends on the required resolution that itself depends on the technological node. For example, for a 45 nm technological node with an acceptable measurement error of 10%, the resolution R of the method according to the invention must be less than or equal to 4.5 nm. In denoting the length of the contour between flanks F1 and F2 as L, the number of points N used should be equal to at least the ratio L/R. The method according to the invention can thus be used in different modes: a first standard mode in which the number N is equal to approximately UR, a second finer mode in which N is greater than UR and a third very fine mode in which N is very much greater than L/R. The number of processed points will increase as the depth in the technological nodes is increased.

We will assume N=5 in the following, simply for illustrative purposes and to simplify FIG. 4; in other words, we will assume that 5 points are sufficient to characterise the pattern MR with sufficient resolution.

The pattern MR is shown in a two-dimensional coordinate system, in this case an orthonormal coordinate system composed of two axes, (OX) and (OY) graduated with the same unit (OI=OJ=1 unit), perpendicular to each other and with the same origin O.

In this case the origin O is located at the bottom of the first vertical flank F1 such that starting from O, we will be able to scan the entire contour with length L connecting the two flanks F1 and F2 (we will see later that the situation might be different in the case of a pattern with an axis of symmetry).

We will then sample the contour located between the flanks, by defining the sampled points (Xi, Yi) located on the contour where i varies from 1 to N, Xi and Yi being the abscissa and ordinate respectively of the point. The resolution is given by the sampling step corresponding to the difference between the abscissas of two consecutive points (Xi+1−Xi).

In step 103, since the pattern MR does not have an axis of symmetry, point O is considered as being the reference point such that the entire contour to be characterised can be covered. It will be seen that the first sampled point (X1, Y1) corresponds to point O in the case in FIG. 4.

Step 104 to determine a plurality of coefficients is shown with reference to FIG. 5.

Once the points (Xi, Yi) have been determined, the step 104 will consist of comparing each of these points (Xi, Yi) with abscissa Xi with a corresponding point (Xi, Ymi) with abscissa Xi belonging to the contour of the reference pattern MI. As mentioned above, in the ideal case, the shape of the expected reference pattern MI is the shape of a line made by optical lithography, close to a perfect rectangle. Thus in the case shown in FIG. 5, the ordinates of the points (Xi, Ymi) are all equal to each other (and equal to the ordinate Y1 of the first point (X1, Y1) of the contour of the pattern MR).

The ideal difference between the contours of the patterns MR and MI are shown by the cross-hatched zone Z.

For each pair of points (Xi, Yi) and (Xi, Ymi), step 104 will consist of calculating an intermediate coefficient Ci (where i varies from 1 to N and N is the number of points determined in step 102); this coefficient is a dimensionless correlation coefficient representative of the difference between the two points; for example, the coefficient Ci may be given by the following formula:

$$Ci ( \% ) = \frac{( Ymi - Yi ) * 100}{Ymi}$$

This intermediate coefficient Ci is expressed as a %. As Ci becomes closer to 0%, the point (Xi, Yi) becomes closer to the ideal point (Xi, Ymi). It should be noted that it would also be possible to consider a complementary coefficient (in this case, as the coefficient C′i becomes closer to 100%, the point (Xi, Yi) becomes closer to the ideal point (Xi, Ymi)):

$${C}^{′} i ( \% ) = \frac{Yi * 100}{Ymi}$$

In step 105, a final dimensionless coefficient C final is determined starting from the set of intermediate coefficients Ci determined in step 104.

For example, this final coefficient may be the average of coefficients Ci given by the following formula:

$$Cfinal ( \% ) = \frac{{\sum }_{i = 1}^{i = N} Ci}{N}$$

This dimensionless parameter C_{final} is representative of the difference between the global contour of pattern MR and the global contour of the reference pattern MI. This new parameter has two major advantages over dimensions usually used in CD metrology. Firstly, it is a coefficient representative of the global contour (therefore it is not local, unlike CD measurements); therefore it can give a precise and global image of the fabricated pattern regardless of the measured level. It is also a dimensionless (i.e. without units) coefficient that is therefore decorrelated from the calibration of measurement machines.

It should be noted that this coefficient C_{final} may also be normalised by dividing it by 100.

The calculation of the average of coefficients Ci to determine C_{final} is simply one example; the method according to the invention is also applicable to other dimensionless parameters, for example the median of samples Ci; it can easily be imagined that the most appropriate method will be chosen for calculating the coefficient C_{final} depending on whether the ordinates Yi of points (Xi, Yi) are close or at a distance (typically the average when the ordinates Yi are close and the median for example for a Gaussian type distribution).

Step 106 then consists of comparing the value of the final coefficient C_{final} with a predetermined threshold value so as to determine if the pattern MR is acceptable (i.e. sufficiently close) to the reference pattern. The criteria for determining this threshold value may obviously vary depending on the type of the pattern and the fabrication requirements (for example production or R&D).

As we have already explained, step 103 consists of fixing a reference point from which sampling of points of the profile to be characterised will begin.

If the pattern MR does not have an axis of symmetry (case in FIGS. 4 and 5), point O is chosen to cover the entire contour to be characterised. FIG. 6 shows a pattern MR′ for which the contour has an axis of symmetry YY′ such that the contour has two half contours MR1 and MR2 that are symmetric about the YY′ axis. Since the two half-contours MR1 and MR2 are practically identical, there is no point in sampling the entire image; it is sufficient to sample half the contour, for example MR2 (sampling points M1 to M5 are shown in FIG. 6). In this case, the reference point that forms the origin of the orthonormal coordinate system (O,i,j) and the sampling start point is chosen such that sampling is only done on half the contour. The fact that the symmetry of the contour is used advantageously saves calculation time for a given resolution, or alternately the resolution can be better for a given calculation time.

FIGS. 7 and 8 each show an image of a pattern obtained by scanning electron microscopy with a resolution of 1 nm, the images in FIGS. 7 and 8 being images of different patterns: the contours obtained after sampling of the patterns in FIGS. 7 and 8 are shown in solid lines. The ideal pattern (identical for the two images in FIGS. 7 and 8) is shown in dashed lines. It can be seen that the pattern in FIG. 8 has re-entrant flanks that are significantly different from the ideal pattern, while the pattern in FIG. 7 is much more similar to the ideal pattern. By determining the final coefficient for each pattern (FIGS. 7 and 8), the method according to the invention can give a precise image of the difference from the ideal pattern.

Obviously, the invention is not limited to the embodiment hat has just been described.

Thus, even though the invention has been specifically disclosed for the case of sampled points identified in an orthonormal coordinate system, it is understood that the method according to the invention would be applicable to all types of coordinate systems (orthogonal or not, normal or not, coordinate systems with polar coordinates, etc.).

1. A method of characterising a pattern comprising:
determining an image of a contour of the pattern to be characterised using imagery instrumentation;
processing said image, said processing including determining a plurality of points located along said contour and sampled at a given sampling rate;
for each point, identifying a point located on a reference contour and corresponding to a same sampling step number and determining an intermediate dimensionless coefficient representing a difference between said point and the corresponding point on said reference contour;
determining a final dimensionless coefficient using all intermediate coefficients corresponding to said plurality of points, said final coefficient being representative of the difference between the contour of the pattern to be characterised and the reference contour.

2. The method according to claim 1, wherein the number of points determined along the contour is more than or equal to a ratio between a length of the contour and a predetermined resolution value.

3. The method according to claim 1, wherein each sampled point is identified by a pair of coordinates in a two-dimensional coordinate system, Xi representing the abscissa of the point and Yi representing the ordinate of the point, where i varies from 1 to N where N is the number of sampling points, said determination of the intermediate coefficient of the abscissa point Xi being made by comparing its ordinate Yi with the ordinate Ymi of the reference contour with the same abscissa Xi.

4. The method according to claim 3, wherein said intermediate coefficient Ci of the abscissa point Xi is given by one of the following two formulas:
$$Ci ( \% ) = \frac{( Ymi - Yi ) * 100}{Ymi}$$
$$or$$
$$Ci ( \% ) = \frac{Yi * 100}{Ymi}$$

5. The method according to claim 4, wherein said final dimensionless coefficient C_{final} is given by the following formula:
$$Cfinal ( \% ) = \frac{{\sum }_{i = 1}^{i = N} Ci}{N}$$

6. The method according to claim 1, wherein said determining an image of the contour of the pattern to be characterised is made by imagery instrumentation making use of one of the following techniques:
three-dimensional atomic force microscopy;
scanning atomic force microscopy;
transmission electron microscopy.

7. The method according to claim 6, comprising determining the part of the contour on which sampling is made.

8. The method according to claim 7, wherein only half of said contour is sampled when said contour has an axis of symmetry.
